(19) United States
(12) Patent Application Publication
(10) Pub. No.: US 2023/0356446 A1
(43) Pub. Date: Nov. 9, 2023

(54) METHOD OF MANUFACTURING A PLASTIC HANDLEBAR FOR A TWO-WHEELER

(71) Applicant: Plastic Innovation GmbH, Ottensheim (AT)

(72) Inventor: Umut CAKMAK, Moedling (AT)

(21) Appl. No.: 18/296,239

(22) Filed: Apr. 5, 2023

(30) Foreign Application Priority Data
May 3, 2022 (DE) 10 2022 110 819.8

(51) Int. Cl. B29C 45/43

(52) U.S. Cl. CPC B29C 45/43; B29C 2045/4089

(57) ABSTRACT

The disclosure relates to a method of manufacturing a component composed of a thermoplastic having at least one hollow space in the interior for a two-wheeler by means of plastic injection molding, said method comprising the following steps:
closing the configured injection molding tool;
injecting a plasticized thermoplastic melt into the closed injection molding tool;
injecting at least one fluid into the closed injection molding tool to displace the plastic core from the interior of the component; and
opening the injection molding tool and demolding the component.
wherein the component is a handlebar.

### CROSS-REFERENCE TO RELATED APPLICATION

The present application claims priority to German Patent Application No. 10 2022 110 819.8 filed on May 3, 2022. The entire contents of the above-listed application are hereby incorporated by reference for all purposes.

### TECHNICAL FIELD

The disclosure relates to a method of manufacturing a plastic component having at least one hollow space in the interior, said plastic component being a handlebar for a two-wheeler. A two-wheeler in the sense of the disclosure can, on the one hand, be a conventional bicycle or an electric bicycle. A two-wheeler is, however, furthermore also to be understood as a motorized two-wheeler having a motor/engine such as a motor-assisted bicycle, a moped, a motorcycle, as well as motor scooters and electric scooters.

### BACKGROUND

It is already known to manufacture bicycle handlebars from plastic. For this purpose, a resin injection process is typically used that is known under then name “resin transfer molding” (RTM). In this method, glass fiber fabric and/or carbon fiber fabric are placed into a molding tool. With a closed tool, the fabric is saturated with a thermosetting matrix material such as an epoxy resin or polyurethane that is injected into the tool. The thermosetting matrix materials usually comprise two base substances that have to be mixed well with one another before the introduction into the tool. A chemical reaction takes place after the mixing and the injection into the tool. The component can be demolded after a corresponding conversion of the reactants.

### SUMMARY

The glass fiber fabrics or carbon fiber fabrics are typically arranged in the tool in a three-dimensionally woven state. An inflatable tube is furthermore placed into the interior of the fabric so that the tube can be inflated with a fluid after the resin injection of the tube in the component interior and a hollow space is created in the component. The fluid introduced under pressure is released after the end of the reaction of the reactants. The hardened component can subsequently be removed.

Bicycle handlebars comprising thermosetting matrix material have the great disadvantage in addition to increased production costs that they cannot be sensibly recycled due to the selected material. Apart from a thermal exploitation by combustion there is no reasonable recycling for the components manufactured from thermosetting matrix material.

The aforesaid disadvantages could be remedied by a plastic having thermoplastic material properties. However, completely manufacturing bicycle handlebars from thermoplastics was not done in the known methods due to the poor material properties with regard to the required stability of a bicycle handlebar. Finally, the handlebar is a safety-related component with which a fall or a hard impact from the surface can cause a handlebar fracture with serious consequences. High forces that, in addition to the risk of a handlebar fracture, likewise contribute to a constant strain on the handlebar typically already act on the handlebars on the acceleration and braking of the two-wheeler.

Starting from the disadvantages outlined above, it is therefore the underlying object of the present disclosure to provide a reliable method with which a two-wheeler handlebar can be manufactured completely from a thermoplastic, that satisfies safety-related demands, and that can be recycled in a simple manner.

In accordance with the disclosure, a method of manufacturing a component of thermoplastic in accordance with the features of claim 1 having at least one hollow space in the interior for a two-wheeler by means of plastic injection molding is provided to achieve this object in accordance with the disclosure, with preferred embodiments being the subject of the dependent claims.

The method in accordance with claim 1 accordingly takes place as follows:
closing the configured injection molding tool;
injecting a plasticized thermoplastic melt into the closed injection molding tool;
injecting at least one fluid into the closed injection molding tool to displace the plastic core from the interior of the component; and
opening the injection molding tool and demolding the component.

The sequence of the method in accordance with the disclosure can selectively be adapted by the following steps:
selectively, only a slight post-pressure time of approximately two seconds after the injection of the plasticized plastic melt;
selectively maintaining the fluid pressure for a brief time in the component interior (effect as with a post-pressure);
selectively, flushing process in the component interior by means of the same fluid or of a different fluid to achieve a better cooling effect;
selectively, blowing out the fluid (or sucking out by means of a vacuum).

The fluid used is generally water or gas. It can, however, also comprise both media since, for example, an air bubble is frequently pushed ahead of the water or with nitrogen first being used for forming the hollow space and subsequently CO₂ being used for cooling the component.

In the method in accordance with the disclosure, a cavity of the closed injection molding tool forms the geometry of the component to be produced, wherein a handlebar for a two-wheeler is provided in accordance with the disclosure. The injection molding tool is equipped with at least one injector for the introduction of a fluid. The fluid is able to displace the plastic core from the interior of the component and thus to form a tubular cross-section of the handlebar. In this process, the fluid can be injected with a regulation of volume flow or pressure/time via a preset profile. The cool-down phase of the hot plastic melt can be substantially reduced by the tubular cross-section due to the comparatively thin remaining residual wall thickness. This means that only a comparatively brief cooling time is required.

The method in accordance with the disclosure is characterized overall by a very considerable cooling time reduction with respect to a handlebar of a solid material. The process time for the manufacture of a two-wheeler handlebar can be substantially shortened due to the faster cooling time. It is therefore possible to produce a hollow-walled handlebar for a two-wheeler in a very cost efficient manner with respect to previous methods. The mass of the total two-wheeler frame is furthermore considerably reduced due to the hollow space at the component interior, which not only brings about a weight advantage, but also in particular an economic advantage. A higher stiffness can also be assumed with a closed tubular cross-section. When a tubular cross-section is spoken of here, it can naturally be formed as circular, oval, polygonal, and in any other desired shape.

Advantageous embodiments of the disclosure result from the dependent claims following on from the main claim.

Provision is accordingly made in an advantageous embodiment of the method in accordance with the disclosure that a set fluid pressure of the at least one fluid is maintained over a specific time period in the interior of the component and is blown out, expelled, and/or sucked out after the maintenance.

Provision can further be made in an alternative variant of the method in accordance with the disclosure that the at least one fluid presses the plastic core, for example, into an overflow cavity introduced in the injection molding tool.

In accordance with a further possible embodiment of the disclosure, more than one overflow cavity and/or more than one injection point can be provided in the injection molding tool.

Provision is made in accordance with a variant of the method in accordance with the disclosure that the component is manufactured by the so-called mass back pressure process, wherein the at least one fluid displaces the plastic core back through a channel into the screw antechamber of the injection molding machine and wherein the at least one fluid is injected on the side of the component disposed opposite the corresponding injection point of the melt.

In accordance with an again advantageous embodiment of the method in accordance with the disclosure, the at least one shaping component cavity introduced into the injection molding tool is only partially filled with the advantageously thermoplastic melt and the plastic core is displaced by the injection of the fluid, with the liquid melt being inflated such that it is placed on the wall of the injection molding tool and a hollow space is created in the interior of the component. The at least one shaping component cavity is completely filled as part of this process. The inflation of the melt enables a very economic use of the thermoplastic provided for forming the handlebar.

Alternatively, at least one first shaping component cavity is used in the injection molding tool, with the at least one shaping component cavity being replaceable to generate any desired component geometries by means of additional shaping component cavities.

In accordance with a further advantageous embodiment of the method in accordance with the disclosure, additional metallic components to be integrated in the component such as components of aluminum and/or steel and/or non-metallic components such as pultruded woven or wound glass fiber tubes are placed into the injection molding tool individually or in groups and are back injection molded or overmolded.

In an alternative advantageous method process, unidirectional tapes and/or organosheets (a design and/or functional film and/or a tape of carbon or glass fiber fabric) are placed into partial regions or over a large area in the injection molding tool and are back injection molded, with a connection with the thermoplastic melt with material continuity being produced.

To achieve the best possible connection between the tapes and the thermoplastic melt, the tapes/organosheets can particularly advantageously be preheated to a specific temperature before the placing into the tool, with this specific temperature having to be selected in dependence on the matrix material of the tape.

Provision can alternatively be made that the unidirectional tapes and/or the organosheets are placed into the injection molding tool in a cold and/or in a hot state.

The tapes/organosheets can furthermore be positioned and held by a special apparatus in the tool, for example. The stiffness in critical regions of the component can in particular be increased by a goal-oriented fiber orientation of the tapes/organo sheets.

In accordance with a further advantageous embodiment of the method in accordance with the disclosure, the component is designed as a two-component part of hard and soft components, with components such as grip pieces on the plastic handlebar being formed as soft components that are produced by means of an index plate or turntable injection molding tool or by means of a second cavity arranged in the injection molding tool. Alternatively, provision can be made in accordance with another variant of the method in accordance with the disclosure that the spacers in the grip regions of the handlebar are formed as hard components that are co-injected in the first cavity. In the second cavity, the spacers serve as a centering aid to prevent a crumpling of the component on the injection molding of the soft components.

Another advantageous embodiment of the disclosure in turn provides that a stem is co-injected on the component so that the component and the stem form a common component or that the component has at least one defined interface for the attachment of the stem, with the interface being formed such that different stems correspond via a shape matched connection.

In accordance with an alternative advantageous method process, the at least one interface is an electronic interface for signal transmission.

The method in accordance with the disclosure can advantageously be designed such that water and/or gas, preferably nitrogen, is/are provided as the fluid to be injected that is injected via at least one injector arranged in the tool.

Another advantageous embodiment of the disclosure in turn provides that a plurality of fluids are injected into the injection molding tool and their individual fluid volume flows or pressure/time profiles are regulated separately from one another. On an introduction of a plurality of fluid volume flows by a plurality of injectors, they can be particularly advantageously regulated separately from one another.

In accordance with another advantageous embodiment, elements that are co-injected in the component such as brake lever mounts for brake levers, cable routings for cable lines for electronic signal transmission, or a bell can be integrated. Other elements can furthermore also be integrated in the component. In this case, the elements to be integrated in the plastic handlebar are placed into the injection molding tool individually or group-wise, are held by means of a holding device, and are overmolded with plastic. A handlebar assembly can take place in a particularly efficient and time-saving manner by this method sequence since the handlebar can be removed from the injection molding tool at the same time as the required components in this variant of the method in accordance with the disclosure.

Another advantageous embodiment of the disclosure in turn provides that elevated and/or recessed pockets are integrated in the component to hold elements such as light guides, headlamps, indicators, and/or comparable elements. The elements can be attached in the pockets on the handlebar, for example, on the final assembly of the bicycle.

To form a constant inner diameter, a projectile can additionally be used that has a cross-section corresponding to the hollow space of the plastic handlebar and that is driven forward through the shaping cavity of the injection molding tool by means of the fluid pressure.

Although the fluid primarily serves the formation of the hollow space in the plastic frame, it can thereby be provided with a second benefit in that it is conducted into a circulation flow after the formation of the hollow space so that it now serves the cooling of the plastic material that is still very hot directly after the injection process.

A plastic that is selected from the following groups can advantageously be used in the method in accordance with the disclosure: Polyamide, preferably polyamide 12, polyamide 6 or polyamide 6.6, polypropylene, polyethylene, polyethersulfone, polyetherimide, polyetherketone polyphenylene sulfide, polyvinyl chloride, polyester, acrylonitrile butadiene styrene (ABS), polycarbonate/acrylonitrile butadiene styrene (ABC/PC), polycarbonate (PC), and particularly preferably polybutylene terephthalate or polyterephthalate ethylene. These plastics can here be selected and used individually or in combination. The selected plastics can furthermore also be reinforced via short fibers and/or long fibers composed of glass fibers, carbon fibers and/or natural fibers.

The plastic can alternatively also be injected in the injection molding tool as a caprolactam with an associated activator and can be polymerized in the heated tool.

The handlebar comprising the thermoplastic matrix material can be recycled and thereby reused at any time.

Due to the positive property that the handlebar produced by the method in accordance with the disclosure consists of a thermoplastic, it is not electrically conductive, whereby a disruption free transmission of signals, data, and/or energy can take place. An additional cabling to conduct the produced energy from an energy-generating unit such as a dynamo to the consumer, for example to a bicycle lamp, could also be implemented by means of a correspondingly functionalized film in the hollow space of the component.

The handlebar has a small temperature conductivity due to the advantageous property that it is produced from plastic. This property can in particular be of advantage under poor weather conditions and/or at temperatures below freezing point since the rider can hold the handlebar with one hand (also without gloves) when pushing the bicycle, for example in the region of the stem, without the hand on the handlebar becoming cold as fast as on the holding of a metal handlebar. For due to the high temperature conductivity capability of metal handlebars, the hand on the handlebar cools substantially faster, whereby the rider is no longer able to hold the handlebar in the aforesaid manner after only a short time.

The disclosure finally relates to a handlebar of a thermoplastic for a two-wheeler that is manufactured in accordance with one of the aforesaid embodiments of the method in accordance with the disclosure. Provision can additionally be made in accordance with an alternative embodiment that the handlebar has a main handlebar part and two respectively replaceable end handlebar parts of thermoplastic.

Further details and advantages of the disclosure result from the embodiments shown in the following with reference to the Figures.

### BRIEF DESCRIPTION OF THE FIGURES

The Figures show:

FIG. 1 shows a handlebar in accordance with a first design of the component that was produced by means of the method in accordance with the disclosure;

FIG. 2 shows a handlebar in accordance with a second design of the component that was produced by means of the method in accordance with the disclosure;

FIG. 3 shows the handlebar in accordance with the first design with a handlebar stem and an overflow cavity;

FIG. 4 shows a section through the handlebar stem;

FIG. 5 shows the handlebar of the second design with an overflow cavity;

FIG. 6 shows a section through the handlebar with an overflow cavity shown in FIG. 5;

FIG. 7 shows the handlebar of the second design with holding pockets;

FIG. 8 shows an alternative variant of the handlebar in accordance with FIG. 7;

FIG. 9 shows a section through the handlebar stem of the handlebar of the second design;

FIG. 10 shows the handlebar of the second design with unidirectional tapes and/or organosheets placed in;

FIG. 11 shows a handlebar cover with Integrated functional elements; and

FIG. 12 and FIG. 13 show alternative embodiments of the handlebar produced with the method in accordance with the disclosure.

### DETAILED DESCRIPTION

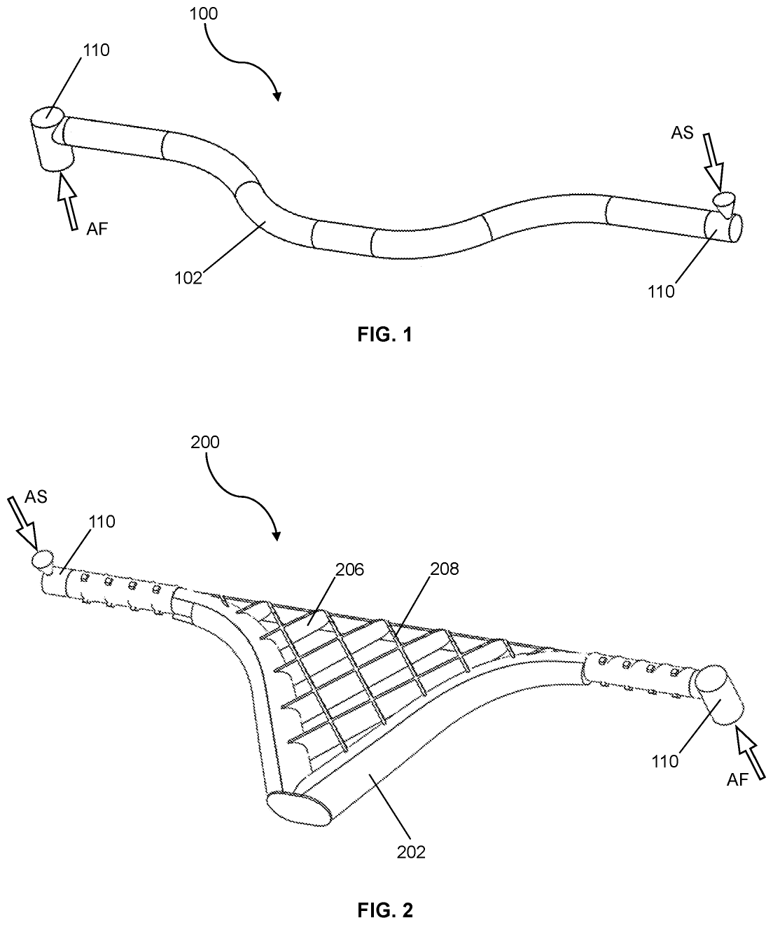

In the embodiments in accordance with FIGS. 1 to 13, those components are looked at in more detail that have been manufactured using the method in accordance with the disclosure or using a variant of the method. The figures are drawn to scale, although other relative proportions may be used, if desired.

A displacement of the plastic core from the component can generally take place in different manners. The components shown in FIGS. 1 and 2 are produced, for example, by a pushing back of the material of the plastic core into the screw antechamber of the injection molding machine. This form of the method process is also called mass back pressure.

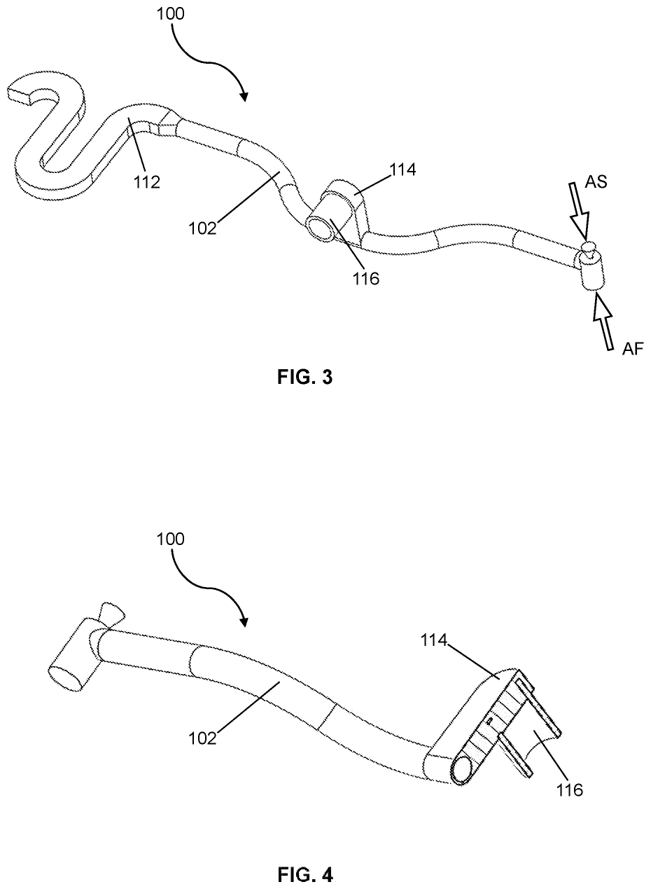

A blowing out of the material of the plastic core into an overflow cavity in accordance with FIGS. 3, 5, and 6 can also take pace instead of the aforesaid method process.

Finally, a blowing out process can also be provided, in which a smaller quantity of thermoplastic is introduced into the injection molding tool that is then inflated. The quantity of the plastic introduced is selected here such that no material is displaced from the injection molding tool on the inflation.

In the embodiments shown, preferably polyamide or polyolefin is used that is reinforced via glass fibers and/or carbon fibers and/or natural fibers.

FIG. 1 schematically shows the component 100 comprising a handlebar 102 for a two-wheeler that was produced in accordance with the method in accordance with the disclosure. FIG. 2 further shows the component 200 comprising a handlebar 202 that corresponds to a second design and that was likewise produced in accordance with the method in accordance with the disclosure. The closed tool in which the handlebars 102 or 202 respectively are placed is not shown in any more detail.

The components 100 and 200 shown in FIGS. 1 and 2 are each produced by the mass back pressure process, wherein the plastic core is displaced back into the screw antechamber of the injection molding machine by the injection of the fluid via a channel, not shown in any more detail. The advancing fluid is injected on the side of the component 100 and 200 respectively oppositely disposed the corresponding injection point AS of the melt. As can further be seen from FIGS. 1 and 2, respective injection elements 100 with the injection points AS or AF are therefore arranged at the ends of the handlebars 102 and 202 respectively shown in FIGS. 1 and 2. The injection point AF is at the injection element 100 arranged at the left side at the handlebar 102 and 202 respectively, while the injection point AS is provided on the oppositely disposed side of the handlebar 102 and 202 respectively.

In accordance with the method in accordance with the disclosure, a plasticized plastic melt is injected at the injection point AS in the arrow direction of the arrow shown, while the fluid is pressed in the arrow direction of the corresponding arrow at the injection point AF after the injection of the melt through an injector not shown in any more detail here, that displaces the so-called plastic core from the interior of the component 100 and 200 respectively.

The tools placed in the injection molding tool form shaping component cavities here. It is possible with reference to these shaping cavities, that are not shown in more detail, to produce hollow-walled components in large volumes having a specific shape in the interior of the component.

In accordance with an alternative variant of the method, the at least one shaping component cavity can be replaceable to be able to produce any desired component geometries by means of additional shaping component cavities.

The plastic handlebar 202 can be additionally reinforced by additional stiffening elements like the ribs 206 and 208 shown in FIG. 2 in that a net-like rib structure of right facing ribs 206 in combination with left facing ribs 208 is formed.

As FIG. 3 shows, the injection points AS and AF can only be arranged on only one side of the component 100 in accordance with an alternative variant of the method in accordance with the disclosure. In this variant, an overflow cavity 112 that is introduced in the injection molding tool and into which the plastic core or the excess plastic material is placed is instead located on the oppositely disposed side of the injection points AS and AF. As soon as the fluid injection and the displacement of the excess plastic material from the component 100 that accompanies it has terminated, the overflow cavity 112 is closed hydraulically, pneumatically, and/or electrically, preferably via a slider not shown in any more detail.

In addition to the already named overflow cavity 112, the representation in accordance with FIG. 3 shows a handlebar stem 114 that is also injected at the handlebar 102 and in which a tubular insert part 116 of aluminum and/or steel has been back injection molded or overmolded.

FIG. 4 shows a section through the handlebar stem 114 shown n FIG. 3 and of the insert part 116.

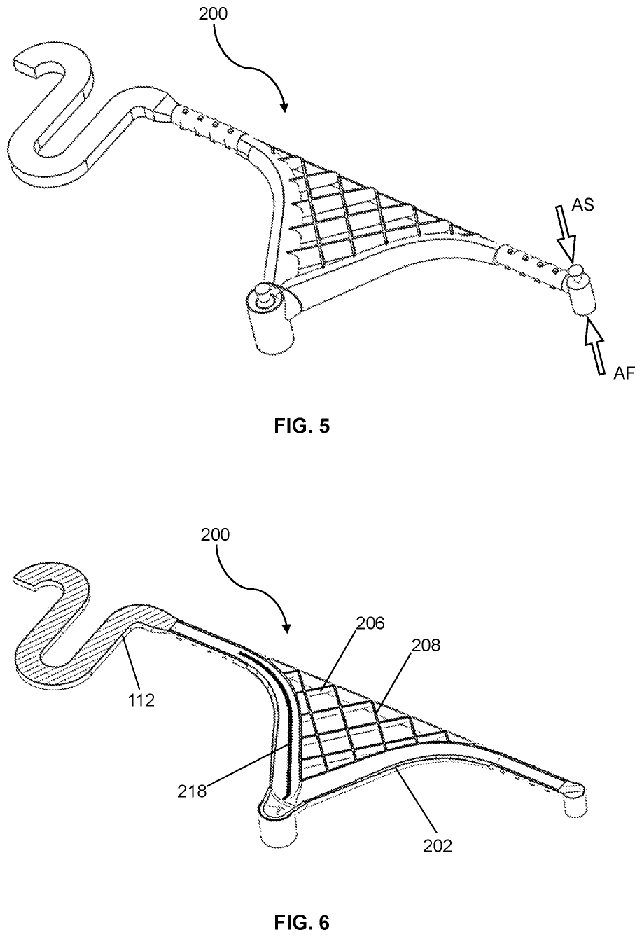

FIG. 5 shows the component 200 with a handlebar stem 214 that is co-injected at the handlebar 202 and that is manufactured in accordance with the aforesaid alternative variant of the method in accordance with the disclosure.

FIG. 6 shows a section through the component 200 and the overflow cavity 112 adjacent thereto so that the hollow space in the handlebar 202 can be recognized. The hollow space can be provided as a cable routing 218 to connect a connection between electronic devices arranged at the handlebar and/or in the handlebar to other electronic devices attached to the two-wheeler. It is particularly advantageous here that the cables extending in the hollow space of the handlebar 202 can lead by means +f the cable routing 218 directly via the hollow-walled stem 214 into the frame of the two-wheeler. Alternatively, the hollow space of the handlebar 202 can also be used as a routing for brake and/or shift cables. A routing of hydraulic brake lines or the like would also be conceivable here.

In accordance with another variant of the method in accordance with the disclosure, more than one overflow cavity 112 and/or more than one injection point AS and AF can also be provided in the injection molding tool, in particular with complex designs of the component 100 and 200.

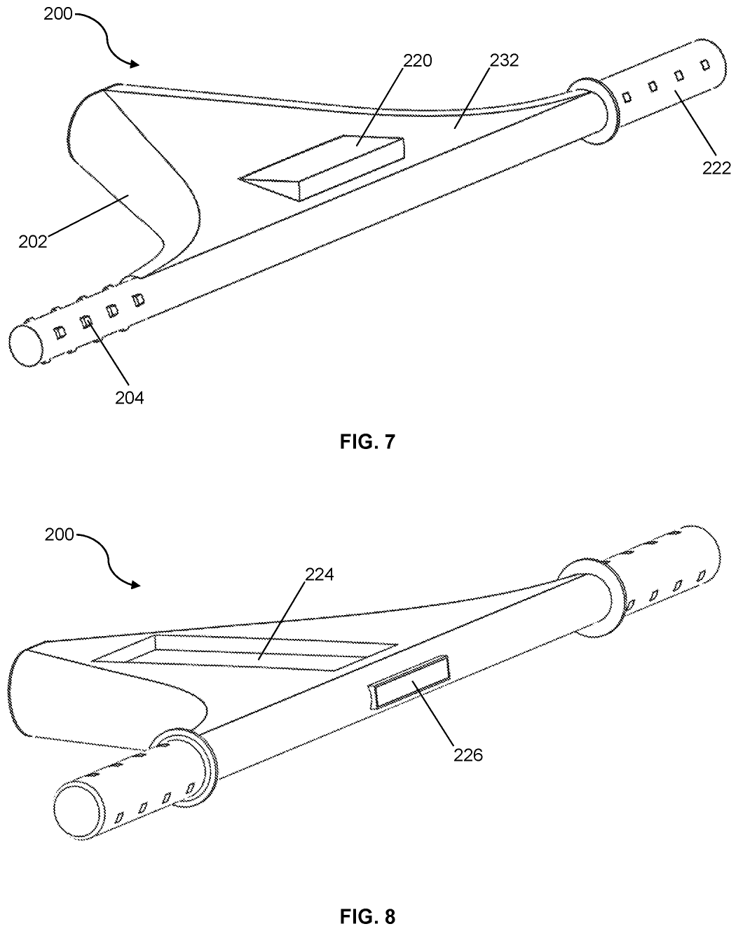

In accordance with the representation of FIG. 7, the component 200 is formed as a two-component element of hard components and soft components. In this variant of the method in accordance with the disclosure, the hard components such as the spacers 204 disposed in the grip regions of the component are first co-injected in a first cavity. The spacers 204 can then advantageously be used as a centering aid in a second cavity to prevent a deformation of the component provided with the spacers on the injection molding of the soft components such as the grip piece 222.

In accordance with FIGS. 7 and 8, elevated pockets 220 and/or recessed pockets 224 for holding elements such as light guides, headlamps, indicators, and/or similar elements can be integrated in the cover 232 of the handlebar. In accordance with FIG. 8, a pocket 226 can furthermore be integrated between the grip regions of the handlebar 202.

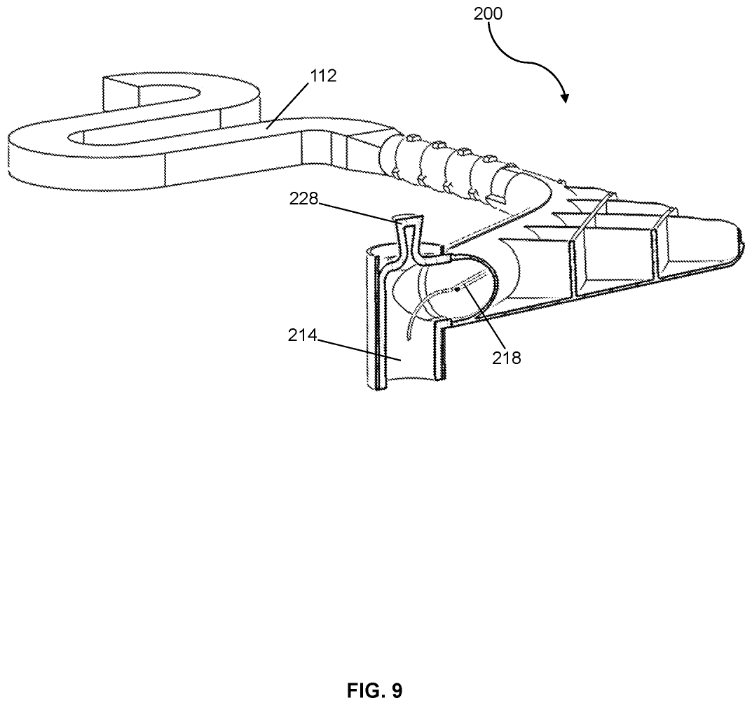

The sectional representation of FIG. 9 shows a metallic or non-metallic insert 228 that is integrated in the stem 214 of the handlebar 202 and that is placed into the stem and overmolded as a reinforcement element in an alternative variant of the method in accordance with the disclosure. At the same time, the hollow-walled design of the insert 228 can be provided as a continuation of the cable routing 218.

To increase the strength of the handlebar structure, in accordance with an alternative variant of the method in accordance with the disclosure, unidirectional tapes and/or organosheets 230 can be placed into partial regions of the injection tool or over a large area into the injection tool and can be subsequently back injection molded in the component prior to the injection of the plastic melt. A connection with material continuity to the thermoplastic melt is formed here. A structural failure of the handlebar can be precluded in this manner, even on particularly high strains.

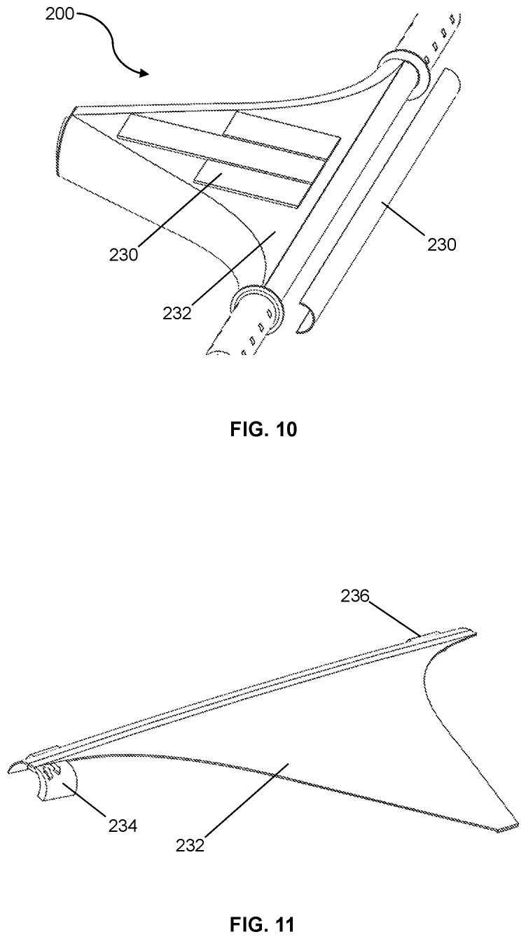

As shown in FIG. 10, the unidirectional tapes and/or organosheets 230 can be provided in any desired partial regions of the handlebar. For example, directly on the cover 232 and/or in a region disposed between the grips.

FIG. 11 shows a further development of the cover 232 with co-injected functional elements such as brake mounts, cable routings, a bell, and/or other elements. An integrated shift function 234 as well as an additional pocket 236 for a light integration are furthermore shown in the representation of FIG. 11.

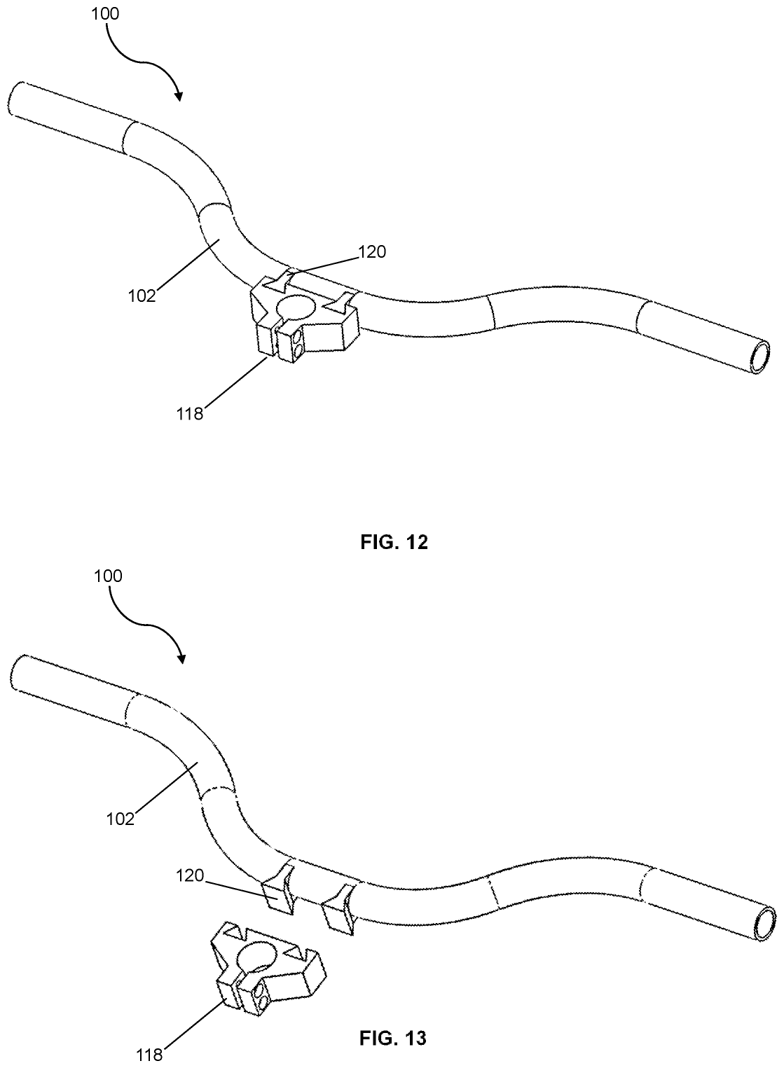

FIGS. 12 and 13 represent an alternative design of a handlebar produced by means of the method in accordance with the disclosure. The special aspect of the embodiment of the handlebar shown in FIGS. 12 and 13 is represented by the fastening between the handlebar 102 at the stem 118. As said Figures show, co-injected sections 120 are integrated at the handlebar 102. Nevertheless, the stem 118 has sections corresponding to the sections 120 integrated at the handlebar 102. The handlebar 102 can in this manner be fastened to the stem 118 in a time saving and simple manner, i.e. without technical aids, by means of the integrated sections 120. The replacement of a damaged handlebar 120 is thereby simplified in a particularly advantageous manner. Any other embodiments of the handlebar 102 that are compatible with the stem 118 can naturally be produced using the method in accordance with the disclosure.

FIG. 12 shows the handlebar 102 attached to the stem 118. The handlebar 102 and the stem 118 that are already known from FIG. 12 are shown again separate from one another in FIG. 13.

In addition to the possibility of designing a handlebar produced by means of the method in accordance with the disclosure shown in FIGS. 12 and 13, it would equally be conceivable that two insertable handlebar end parts of thermoplastic are provided at the handlebar. An uncomplicated replacement is flexibly performable by the insertion of the right or left handlebar end part. This principle can prove advantageous on damage to the handlebar or in general.

All in all, the present disclosure represents an excellent solution with respect to the manufacture of components of thermoplastics for two-wheelers.

### REFERENCE NUMERAL LIST

100 component of a first design
102 handlebar
110 injection elements
112 overflow cavity
114 stem
116 tubular insertion part
118 stem with section
120 integrated section
200 component of a second design
202 handlebar
204 spacer
206 right facing rib
208 left facing rib
214 stem
218 cable routing
220 elevated pockets
222 grip pieces
224 recessed pockets
226 pocket
228 metallic/non-metallic insert
230 unidirectional tapes and/or organosheets
232 cover

1. A method of manufacturing a component composed of a thermoplastic having at least one hollow space in an interior for a two-wheeler by means of plastic injection molding, said method comprising the following steps:
closing a configured injection molding tool;
injecting a plasticized thermoplastic melt into the closed injection molding tool;
injecting at least one fluid into the closed injection molding tool to displace a plastic core from the interior of the component;
opening the injection molding tool and demolding the component,
wherein the component is a handlebar.

2. A method in accordance with claim 1, wherein a set fluid pressure of the at least one fluid is maintained over a specific time period in the interior of the component and is blown out, expelled, and/or sucked out after maintenance.

3. A method in accordance with claim 1, wherein the at least one fluid presses the plastic core into an overflow cavity introduced in the injection molding tool.

4. A method in accordance with claim 3, wherein more than one overflow cavity and/or more than one injection point is/are provided in the injection molding tool.

5. A method in accordance with claim 1, wherein the component is manufactured by a mass back pressure process, with the at least one fluid displacing the plastic core back through a channel into a screw antechamber on the injection molding tool and with the at least one fluid being injected on the side of the component disposed opposite the corresponding injection point of the melt.

6. A method in accordance with claim 1, wherein at least one shaping component cavity introduced into the injection molding tool is only partially filled with the thermoplastic melt and the plastic core is displaced by the injection of the fluid, with the liquid melt being inflated such that it is placed on the wall of the injection molding tool and a hollow space is created in the interior of the component, and with the at least one shaping component cavity being completely filled.

7. A method in accordance with claim 1, wherein at least one first shaping component cavity is used in the injection molding tool, with the at least one shaping component cavity being replaceable to generate any desired component geometries by means of additional shaping component cavities.

8. A method in accordance with claim 1, wherein additional metallic components to be integrated in the component such as components of aluminum and/or steel and/or non-metallic components such as pultruded woven or wound glass fiber tubes are placed into the injection molding tool individually or in groups and are back injection molded or overmolded.

9. A method in accordance with claim 1, wherein unidirectional tapes and/or organosheets are placed and back injection molded in partial regions of the injection molding tool or over large areas before the injection of the plastic melt, with a connection to the thermoplastic melt with material continuity being produced.

10. A method in accordance with claim 9, wherein the unidirectional tapes and/or the organosheets are placed into the injection molding tool in a cold and/or in a hot state.

11. A method in accordance with claim 1, wherein the component is designed as a two-component part of hard and soft components, with components such as grip pieces on the plastic handlebar being formed as soft components that are produced by means of an index plate or turntable injection molding tool or by means of a second cavity arranged in the injection molding tool.

12. A method in accordance with claim 11, wherein hard components are co-injected in the first cavity in the grip regions of the component and the spacers in the second cavity serve as a centering aid to prevent a deformation of the component on the injection molding of the soft components.

13. A method in accordance with claim 1, wherein a stem is co-injected on the component so that the component and the stem form a common component; or in that the component has at least one defined interface for the attachment of the stem, with the interface being formed such that different stems correspond via a shape matched connection.

14. A method in accordance with claim 13, wherein the at least one interface is an electronic interface for signal transmission.

15. A method in accordance with claim 1, wherein water and/or gas, preferably nitrogen, is/are provided as the fluid to be injected that is injected via at least one injector arranged in the tool.

16. A method in accordance with claim 1, wherein a plurality of fluids are injected into the injection molding tool and their individual fluid volume flows or pressure/time profiles are regulated separately from one another.

17. A method in accordance with claim 1, wherein co-injected elements such as brake lever mounts, cable routings, a bell, and/or other elements are integrated in the component.

18. A method in accordance with claim 1, wherein elevated and/or depressed pockets are integrated in the component to hold elements such as light guides, headlamps, indicators, and/or comparable elements.

19. A handlebar of thermoplastic for a two-wheeler, wherein the handlebar is manufactured using the method in accordance with claim 1.

20. A handlebar in accordance with claim 19, wherein the handlebar has a main handlebar part and two respectively replaceable end handlebar parts of thermoplastic.
